(19) United States
(12) Patent Application Publication
(10) Pub. No.: US 2008/0075917 A1
(43) Pub. Date: Mar. 27, 2008

(54) Curved Honeycomb Structure and Method for Producing the Same

(75) Inventor: Kiho Park, Inchon (KR)

Correspondence Address: CANTOR COLBURN, LLP, 20 Church Street, 22nd Floor, Hartford, CT, 06103, US

(73) Assignees: Hoejung YANG, Yongsin-si (KR); Bongwoo LEE, Cheonan-si (KR)

(21) Appl. No.: 11/718,334

(22) PCT Filed: Oct. 28, 2005
(86) PCT No.: PCT/KR05/03605

§ 371 Date: May 1, 2007

(30) Foreign Application Priority Data
Nov. 3, 2004 (KR) 10-2004-0089068

(51) Int. Cl. B32B 3/12; B29C 39/00

(52) U.S. Cl. 428/117; 264/630

(57) ABSTRACT

Disclosed herein is a curved honeycomb structure. The curved honeycomb structure is easily produced by placing respective flat plates composed of metallic or plastic material between moulds of a press machine or vacuum molding machine for forming a curved shape, forming honeycomb-shaped hexagonal cell pillars to protrude from a surface of each curved plate, followed by engaging the hexagonal cell pillars of the upper and lower plates with each other, and bonding them to each other. During forming the honeycomb structure, the hexagonal cells are not crushed or extended, and the strength of the honeycomb structure is substantially the same as that of the flat plate. In addition, the curved plate can have various shapes, and the productivity can be enhanced without increased material consumption.

### TECHNICAL FIELD

The present invention relates to a curved honeycomb structure, and a method for producing the same. More particularly, the present invention relates to a curved honeycomb structure, which has a light weight, and is formed of a composite material to have a curved shape, and a method for producing the same.

### BACKGROUND ART

A honeycomb structure is an ultra-lightweight material, and evaluated as one of the most important composite materials spotlighted in 21 century. In particular, a honeycomb sandwich structure has excellent properties overwhelming other materials in terms of strength to weight. As a result, the honeycomb structure is widely used in various applications for aviation and space industry, shipbuilding industry, automobile industry, construction industry, electronics, leisure-sports industry, etc., which require lightweight and strong materials.

Generally, the honeycomb structure is formed by producing a square block of a honeycomb core and then cutting the block into a desired shape by a method disclosed in U.S. Pat. No. 2,518,164 entitled “Apparatus for producing composite sheet material,” which is so called a corrugation method, or a method disclosed in U.S. Pat. No. 2,983,640 entitled “Method of malting honeycomb”, which is so called an expansion method. In this regard, although it is not difficult to produce a planar honeycomb structure by horizontally cutting the square honeycomb core, it is difficult to produce a curved honeycomb structure by cutting the square honeycomb core into a curved shape.

According to one of the methods for producing the curved honeycomb structure, the planar honeycomb structure is bent, cut, or bonded to form a curved shape. For example, in a method disclosed in U.S. Pat. No. 6,272,897 entitled “Method of forming honeycomb panels into compound curved shapes,” a honeycomb sandwich panel is placed on a predetermined mold, and then compressed by a press machine to form the curved honeycomb structure. However, in this case, when the honeycomb sandwich panel is compressed by the press machine, a face sheet of the honeycomb sandwich panel is often tom. Thus, in order to solve this problem, it is necessary for the method of the disclosure to reinforce the torn portion by covering it with a new face sheet after pressing. In addition, during operation of the press machine, hexagonal cells at the compressed portion are crushed or elongated, thereby deteriorating the strength of the honeycomb structure all the more.

As another example, in a method disclosed in U.S. Pat. No. 5,126,183 entitled “Curved paneling including honeycomb core material having crimps in one edge,” a curved honeycomb core is formed to have crimps on one side of the honeycomb core during formation of the honeycomb core before producing a honeycomb sandwich structure such that the crimps are not formed on the other side thereof so that one side of the honeycomb core has a different length from the other side. However, even in this case, since a bending direction of the honeycomb core is restricted to only one direction, there is a problem in that various shapes of honeycomb structure cannot be produced.

In manufacture of a certain component using the honeycomb structure, for example, as in Hexcel Corporation or Cellbond Corporation in USA, or by EURO-Composite Corporation in Europe, which are the largest companies in the field of manufacturing the honeycomb structure, many processes for manufacturing the component, such as cutting, bending, bonding, and the like, are performed depending on skilled hands, thereby causing a lower manufacturing speed while increasing manufacturing costs. In addition, after cutting or machining the honeycomb core, a great amount of material is removed as remains, so that productivity of manufacturing the component is lowered in comparison to an amount of material supplied for producing the component, thereby increasing a price of the component.

The present invention is conceived to provide a curved honeycomb structure formed by improving a method for producing the honeycomb structure, which is disclosed in Korean Utility Model Registration No. 0350066, entitled “Method for producing a honeycomb structure,” and Korean Utility Model Registration No. 0354808, entitled “Honeycomb panel,” both of which are issued to the applicant of the present invention, and comprise the steps of pressing or vacuum molding metal or plastic plates to form hexagonal-cell upper and lower plates, each having hexagonal cell pillars formed thereon, engaging and bonding to each other, and attaching face sheets to opposite surfaces of the upper and lower plates to produce a honeycomb structure.

### DISCLOSURE OF INVENTION

Technical Problem

As such, the conventional technique for producing a curved honeycomb structure by mechanically bending, cutting or bonding planar honeycomb structures has the problem in that the face sheet of the honeycomb structure is torn, the conventional technique for producing the curved honeycomb structure by compressing the honeycomb sandwich panel using the press machine has the problem in that the hexagonal cells are crushed, thereby lowering the strength of the honeycomb structure, the conventional technique for producing the curved honeycomb structure by forming the crimps on one side of the honeycomb core, followed by bending the honeycomb core has the problem in that, since the bending direction is limited to one side, it is difficult to produce the honeycomb structure having various shapes, and the conventional technique for producing the curved honeycomb structure by cutting, bending, and bonding has the problem in that the productivity is deteriorated, resulting in an increase of material consumption. Therefore, the present invention has been made in view of the above problems, and it is an object of the present invention to provide a curved honeycomb structure which can be easily produced to have various shapes by using specific moulds for a desired utility.

Technical Solution

In accordance with an aspect of the present invention, the above and other objects can be accomplished by the provision of a curved honeycomb structure, comprising: upper and lower plates composed of a metallic or plastic material, and having a curved shape formed by a mould; hexagonal cell pillars protruded upwardly and downwardly from surfaces of upper and lower plates by moulds having protrusions and depressions of hexagonal cell pillar shapes formed on surfaces of the moulds, respectively, such that the hexagonal cell pillars of the upper and lower plates are engaged and bonded to each other to form a honeycomb structure; and curved upper and lower face sheets composed of various materials, and attached to opposite surfaces of the upper and lower plates where the hexagonal cell pillars are not formed.

In accordance with another aspect of the present invention, there is provided a method for producing a curved honeycomb structure, comprising the steps of: positioning respective flat plates composed of a metallic or plastic material between moulds having a curved shape, followed by compressing the flat plates to form respective curved plates; positioning the curved plates between moulds having protrusions and depressions of hexagonal cell pillar shapes, followed by compressing the curved plate using a press machine or a vacuum molding machine so as to form hexagonal cell pillars on a surface of each curved plate; disposing the curved plates to face each other as a hexagonal cell upper plate and a hexagonal cell lower plate, followed by engaging and bonding the hexagonal cell pillars of the hexagonal cell upper and lower plates to each other to form a curved honeycomb block; and attaching curved upper and lower face sheets composed of various materials to other surfaces of the upper and lower plates where the hexagonal cell pillars are not formed.

Advantageous Effects

As apparent from the above description, according to the present invention, the respective flat plates composed of the metallic or plastic material are placed between the moulds having the engrosses and the engraves of the hexagonal cell pillar shapes, and compressed to the curved plate using the press machine or the vacuum molding machine so as to form the honeycomb-shaped hexagonal cell pillars on the surface of each curved plate, followed by engaging and bonding the hexagonal cell pillars of the hexagonal cell upper and lower plates to each other, thereby easily forming the curved honeycomb structure. As a result, the hexagonal cells are not crushed or extended, and the strength of the honeycomb structure is substantially the same as that of the flat plate. In addition, it is possible to form the curved plate having various shapes, and to enhance the productivity without increased material consumption.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a curved honeycomb structure in accordance with the present invention;

FIG. 2 is a side view illustrating the state wherein a flat plate to be formed to a curved plate is placed between a concave upper mould and a convex lower mould;

FIG. 3 is a perspective view illustrating the curved plate formed by the moulds of FIG. 2 on which locations to form hexagonal cell pillars downwardly are marked;

FIG. 4 is a perspective view illustrating the curved plate formed by the moulds of FIG. 2 on which locations to form hexagonal cell pillars upwardly are marked;

FIG. 5 is a perspective view illustrating a honeycomb structure constituted by continuous connection of hexagonal cells when assuming that the curved plate of FIG. 3 is coupled to the curved plate of FIG. 4;

FIG. 6 is a side view illustrating moulds for forming the curved upper and lower plates having the hexagonal cell pillars;

FIG. 7 is a perspective view illustrating an upper plate having the hexagonal cell pillars downwardly protruding from the surface thereof formed by the moulds of FIG. 6;

FIG. 8 is a perspective view illustrating a lower plate having the hexagonal cell pillars upwardly protruding from the surface thereof formed by the moulds of FIG. 6;

FIG. 9 is a perspective view illustrating a honeycomb block produced by engaging the upper and lower plates of FIGS. 7 and 8 in a direction of the hexagonal cell pillars;

FIG. 10 is an assembled perspective view illustrating the curved honeycomb structure having face sheets attached to opposite sides of the upper and lower plates of the honeycomb block of FIG. 9;

FIG. 11 is a plan view illustrating the curved plate on which locations of modified hexagonal cell pillars are marked in the honeycomb structure instead of the hexagonal cell pillars of FIG. 5;

FIG. 12 is a plan view illustrating the curved plate on which locations of modified octagonal cell pillars are marked in the honeycomb structure instead of the hexagonal cell pillars of FIG. 5;

FIG. 13 is a plan view illustrating the curved plate on which locations of modified rectangular cell pillars are marked in the honeycomb structure instead of the hexagonal cell pillars of FIG. 5;

FIG. 14 is a plan view illustrating the curved plate on which locations of modified octagonal cell pillars are marked in the honeycomb structure instead of the hexagonal cell pillars of FIG. 5;

FIG. 15 is a plan view illustrating the curved plate on which locations of modified circular cell pillars are marked in the honeycomb structure instead of the hexagonal cell pillars of FIG. 5;

FIG. 16 is a plan view illustrating the curved plate on which locations of combined polygonal cell pillars are marked in the honeycomb structure instead of the hexagonal cell pillars of FIG. 5;

FIGS. 17 and 18 are perspective views illustrating examples of apertures formed on the upper and lower plates which have the hexagonal cell pillars of FIGS. 7 and 8, respectively;

FIG. 19 is a perspective view illustrating a honeycomb block which is formed by coupling the upper and lower plates of FIGS. 17 and 18, and has apertures punctured therein;

FIGS. 20 and 22 are plan views illustrating curved plates on which cutting lines are drawn before forming the hexagonal cell pillars by a press machine, respectively;

FIGS. 21 and 23 are plan views illustrating the curved plates after the hexagonal cell pillars are formed thereon by pressing, respectively; and

FIG. 24 is a plan view illustrating a curved plate on which two-ply cutting lines are formed before forming the hexagonal cell pillars by the press machine.

### BEST MODE FOR CARRYING OUT THE INVENTION

Preferred embodiments of the present invention will now be described in detail with reference to drawings.

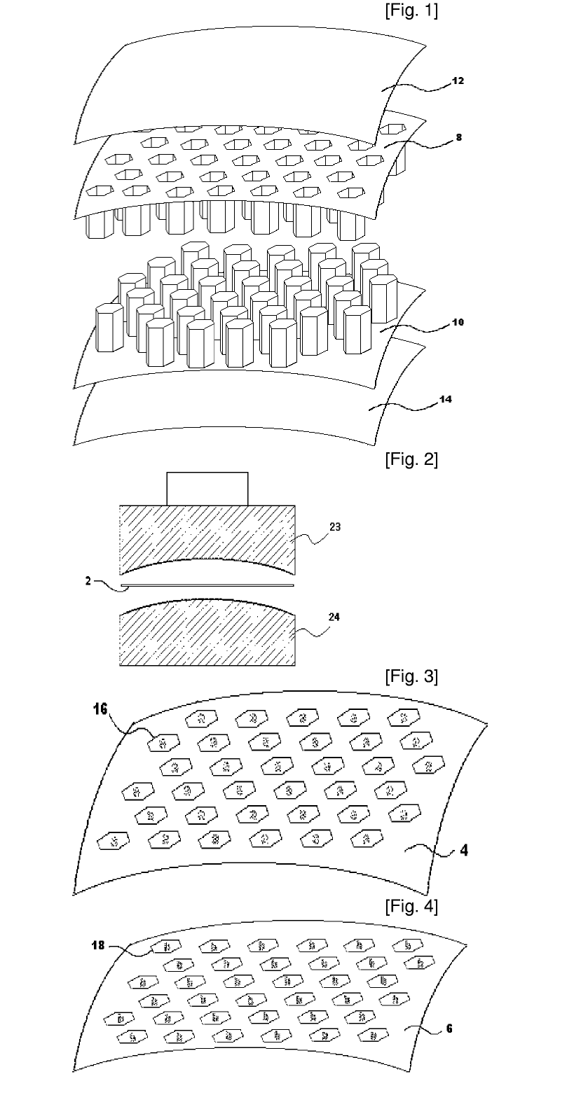

FIG. 1 is an exploded perspective view illustrating a curved honeycomb structure in accordance with the present invention. Referring to FIG. 1, the curved honeycomb structure of the present invention comprises a curved upper face sheet 12, a curved upper plate 8 having hexagonal cell pillars downwardly protruding from the surface thereof, a curved lower plate 10 having hexagonal cell pillars upwardly protruding from the surface thereof, and a curved lower face sheet 14. When these plates are coupled to each other, the curved honeycomb structure as shown in FIG. 10 is formed.

FIG. 2 is a side view illustrating the state wherein a flat plate 2 to be formed to the curved plate 4 or 6, and composed of a metallic or plastic material is placed between a concave upper mould 23 and a convex lower mould 24. According to the material of the flat plate, the flat plate 2 is formed to the curved plate 4 or 6 by the moulds 23 and 24 via pressing or vacuum molding.

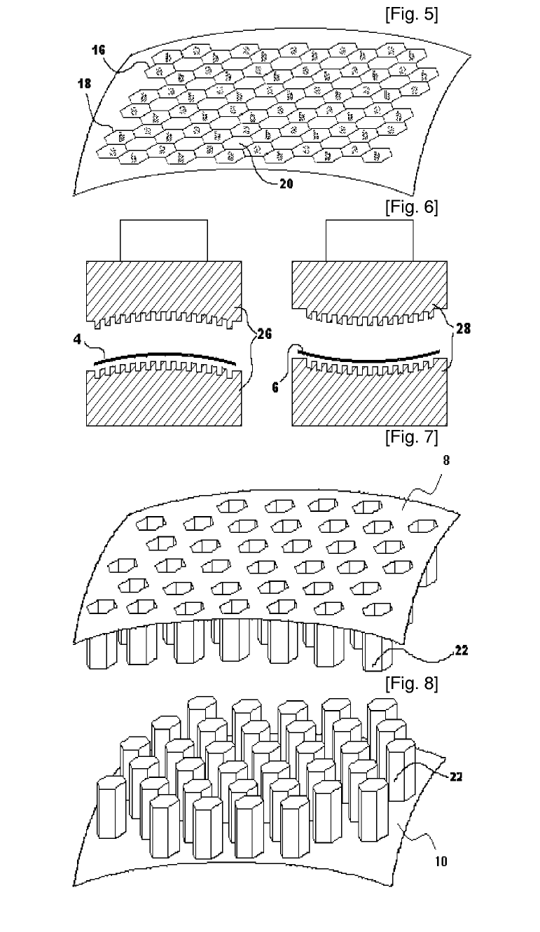

FIG. 3 is a perspective view illustrating the curved plate 4 of the metallic or plastic material, which is formed by the moulds 23 and 24 of FIG. 2, and on which locations 16 to form the hexagonal cell pillars downwardly are marked. Meanwhile, FIG. 4 is a perspective view illustrating the curved plate 6 of the metallic or plastic material, which is formed by the moulds 23 and 24 of FIG. 2, and on which locations 18 to form the hexagonal cell pillars upwardly are marked. FIG. 5 is a perspective view illustrating a honeycomb structure when assuming that the curved plate 4 of FIG. 3 is coupled to the curved plate 6 of FIG. 4. In FIG. 5, hexagonal cells indicted by reference symbols “a” and “b” are continuously connected to each other to form the honeycomb structure, and reference numeral 20 indicates locations of the hexagonal cells formed by connection between the hexagonal cells indicted by the reference symbols “a” and “b”.

According to the present invention, after forming the curved plates 4 and 6 by the moulds 23 and 24 of FIG. 2, the curved plates 4 and 6 are formed into the curved upper plate 8 having hexagonal cell pillars 22 downwardly protruding from the surface thereof as shown in FIG. 7, and the curved lower plate 10 having hexagonal cell pillars 22 upwardly protruding from the surface thereof as shown in FIG. 8 by moulds 26 and 28, each having protrusions and depressions as shown in FIG. 6, for forming the hexagonal cell pillars.

FIG. 6 is a side view illustrating the moulds 26 and 28 for forming the curved upper and lower plates 8 and 10 having the hexagonal cell pillars 22 thereon. As shown in a left side of FIG. 6, the curved upper plate 8 having the hexagonal cell pillars 22 downwardly protruding from the surface thereof as shown in FIG. 7 is formed using the mould 26 which comprises a concave upper mould and a convex lower mould, and as shown in a right side of FIG. 6, the curved lower plate 10 having the hexagonal cell pillars 22 upwardly protruding from the surface thereof as shown in FIG. 8 is formed using the mould 28 which comprises a convex upper mould and a concave lower mould. Accordingly, when upper and lower plates 8 and 10 are coupled to each other, a curved honeycomb structure can be produced, in which the hexagonal cell pillars 22 protruding from the curved upper and lower plates 8 and 10 are engaged to each other.

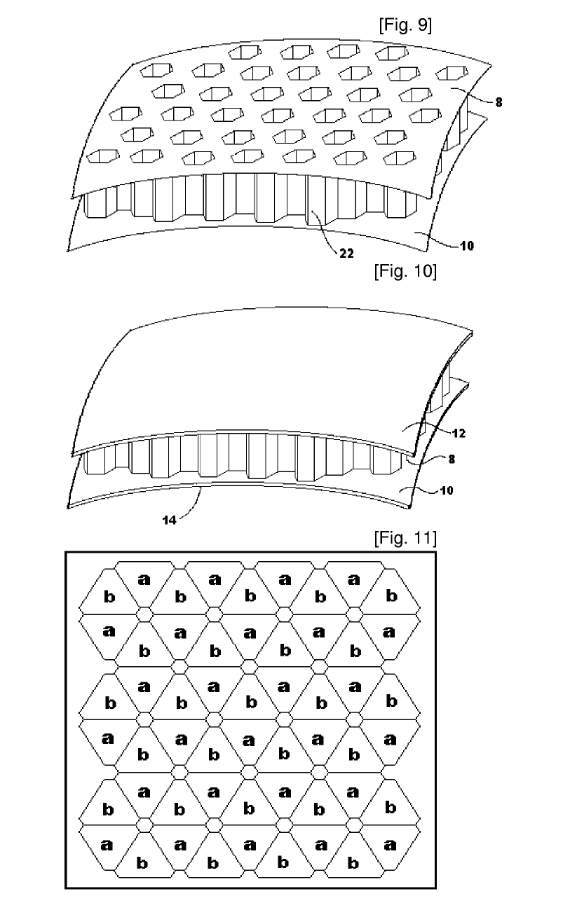

In the curved honeycomb structure of FIG. 9, adhesives are applied to an outer surface of the hexagonal cell pillars 22 or an adhesive molten material is inserted between the hexagonal cell pillars 22, and, when coupling the upper and lower plates 8 and 10, the hexagonal cell pillars 22 of the curved upper plate 8 are fitted to spaces between the hexagonal cell pillars 22 of the curved lower plate 10 or engaged to the hexagonal cell pillars 22 of the curved lower plate 10, so that all hexagonal cell pillars are bonded to each other, thereby forming a honeycomb shape.

Instead of the adhesives or the adhesive molten material, the hexagonal cell pillars 22 of the curved upper and lower plates 8 and 10 may be bonded to each other via thermal bonding after the curved upper and lower plates 8 and 10 are coupled to each other.

Meanwhile, as shown in FIG. 10, the curved upper and lower face sheets 12 and 14 composed of various materials are attached to opposite surfaces of the curved upper and lower plates 8 and 10 of the curved honeycomb structure, where the hexagonal cell pillars 22 are not formed. In this case, attachment of the face sheets 12 and 14 is accomplished via application of adhesives or an adhesive molten material on the surfaces, or via thermal bonding. According to a conventional technique, bonding between the honeycomb core and the face sheet is carried out on a contact between a line and a surface, which inevitably provides a small contact area therebetween, and insufficient bonding strength, thereby causing easy separation of the honeycomb core and the face sheet. However, according to the present invention, bonding between the honeycomb structure and the face sheet is carried out on a contact between faces as shown in FIG. 9, thereby providing a higher bonding strength, so that bonding therebetween is not substantially damaged by external physical force.

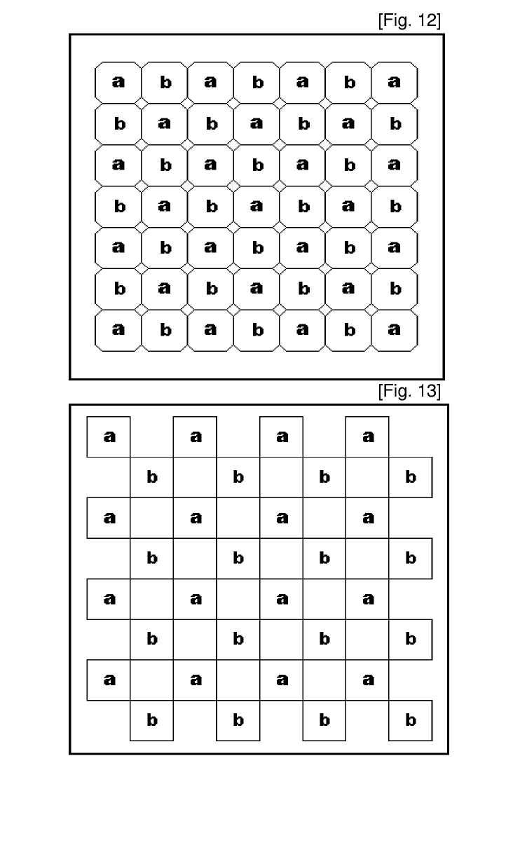

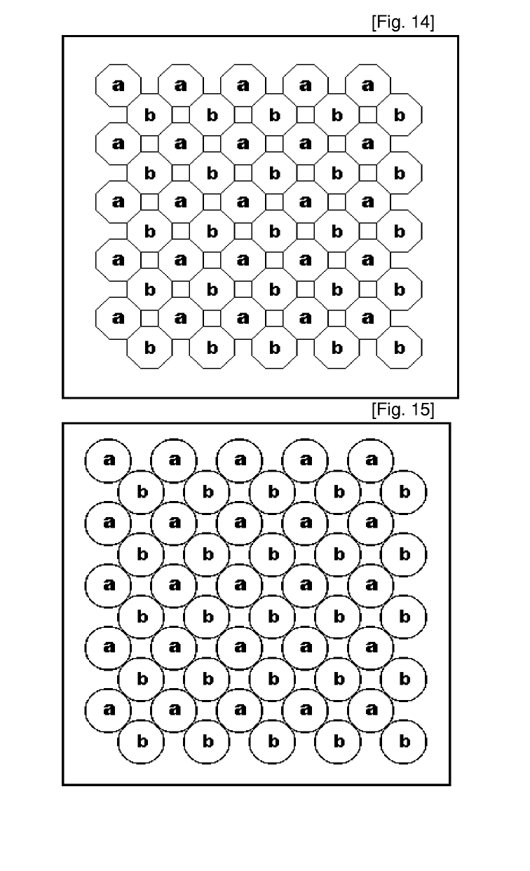

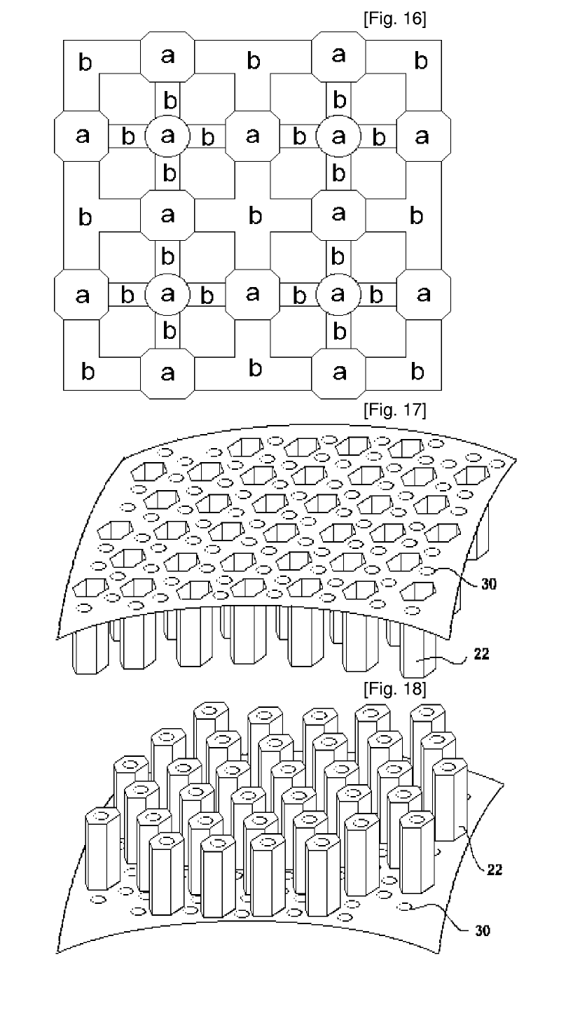

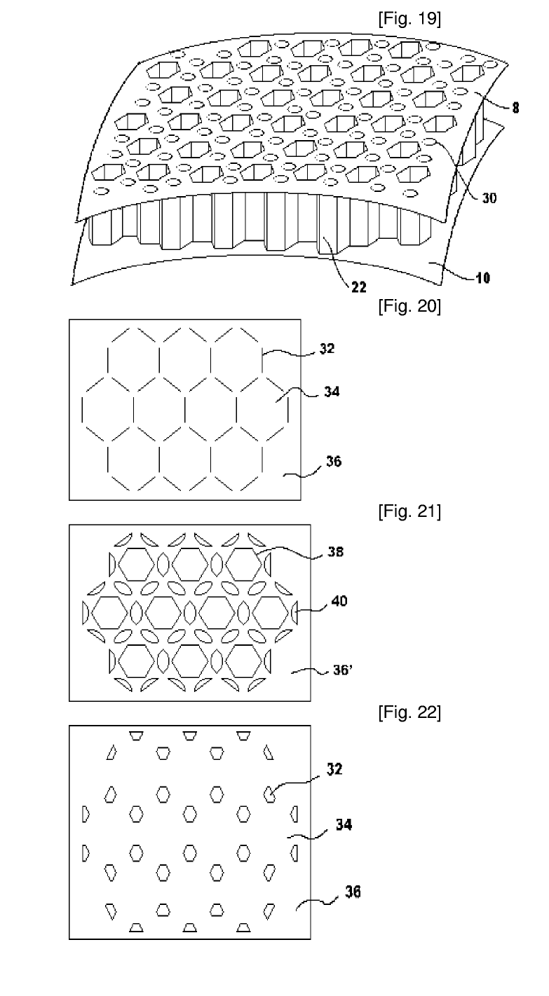

FIGS. 11 to 15 show locations of hexagonal cell pillars having various shapes corresponding to the locations of the hexagonal cell pillars shown in FIG. 5. After producing the moulds to form curved upper and lower plates having the hexagonal cell pillars as shown in FIGS. 11 to 15, the curved upper and lower plates are coupled to each other, thereby forming a curved honeycomb structure. In FIGS. 11 to 15, reference symbol “a” indicates locations of the hexagonal cell pillars having various shapes downwardly protruding from the surface of the curved upper plate, and reference symbol “b” indicates locations of the hexagonal cell pillars having various shapes upwardly protruding from the surface of the curved lower plate. In addition, FIG. 16 shows that cell pillars can be implemented by asymmetric polygonal pillars or pillars of various shapes, for example combinations of rectangular pillars and octagonal pillars or combinations of columns, rectangular pillars, octagonal pillars, and the like. In other words, the cell pillars of the curved upper plate may have different shapes and dimensions from those of the curved lower plate, and the cell pillars of the curved upper or lower plate may have different shapes and dimensions from each other.

FIGS. 17 and 18 are perspective views illustrating examples of apertures 30 formed around each hexagonal cell pillar of the upper and lower plates 8 and 10 after forming the upper plate 8 having hexagonal cell pillars protruding downwardly from the surface thereof, and the lower plate 10 having the hexagonal cell pillars protruding upwardly from the surface thereof. With the apertures 30 punctured around the apertures, when forming the honeycomb structure by bonding the hexagonal cell pillars of the upper and lower plates to each other, the adhesives are not only applied to the surfaces of the upper and lower plates, but also induced into the respective apertures 30, so that horizontal bonding and vertical bonding are achieved by the adhesives, thereby enhancing the bonding strength while reducing the weight of the honeycomb structure. In addition, the apertures 30 can partially prevent gathering of the adhesives or resin.

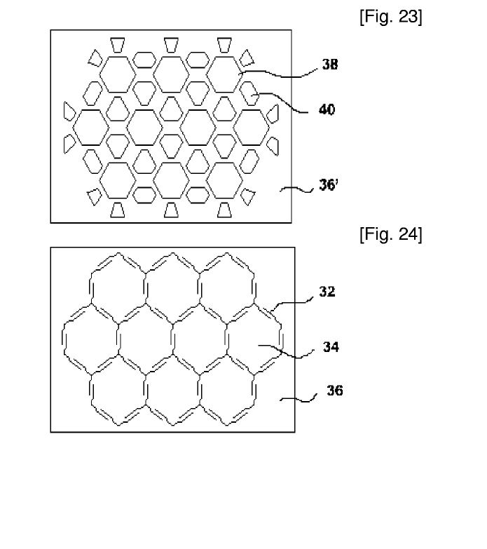

FIGS. 20, 22 and 24 are plan views illustrating curved plates on which cutting lines 32 are previously formed in order to enhance formability of the hexagonal cell pillars on metal plates by the press machine. In the drawings, reference numeral 34 indicates locations of the hexagonal cell pillars, and reference numeral 36 indicates a curved plate to form the hexagonal cell pillars thereon. Generally, it is not easy to form a plurality of hexagonal pillars upwardly on the metal plate by pressing. In addition, it is further difficult to deeply press the hexagonal cell pillars on the metal plate. Accordingly, deep-drawing effect can be achieved by forming the cutting lines 32 on the metal plate, so that the hexagonal pillars can be more deeply formed on the metal plate by pressing. In addition, when two or more-ply cutting lines 32 are alternately formed on the metal plate as shown in FIG. 24, alternately connected portions are extended during forming, and a circumference of each hexagonal pillar is further drawn into a portion formed by pressing. Thus, the two or more-ply cutting lines 32 can be applied to a metallic material having low stretchability. FIGS. 21 and 23 shows examples of the curved plates on which the hexagonal cell pillars are formed by pressing the curved plates of FIGS. 20 and 22, respectively, and shows deformed shapes of the cutting lines which are extended on the curved plate by pressing. In FIGS. 21 and 23, reference numeral 38 indicates the hexagonal cell pillars formed on the curved plate by pressing, reference numeral 40 indicates the cutting lines extended by pressing, and reference numeral 36′ indicates the curved plate which is formed with the hexagonal cell pillars.

The curved upper and lower plates 8 and 10 having the hexagonal cell pillars formed thereon can be formed of various materials according to utility of the honeycomb structure. According to the materials, various molding methods such as Sheet Molding Compound (SMC), Bulk Molding Compound (BMC), Pulp Molding (PM), Reaction Injection Molding (RIM), Resin Transfer Molding (RTM) and the like can be used to form the curved plates which have hexagonal cell pillars formed thereon as shown in FIGS. 7 and 8, and coupled to form the honeycomb structure. According to one method for forming the curved plates which have hexagonal cell pillars formed thereon, a resin comprising woven fabric or non-woven fabric having excellent stretchability therein is placed into moulds, compressed and cured to form the hexagonal cell pillars as shown in FIGS. 7 and 8 to form the honeycomb structure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The method for producing the curved honeycomb structure according to the present invention can be applied to mass production of streamline constructions such as frames of, for example, automobiles or air planes.

1. A curved honeycomb structure, comprising: upper and lower plates composed of a metallic or plastic material, and having a curved shape formed by a mould; polygonal or columnar cell pillars protruded downwardly and upwardly from surfaces of the upper and lower plates by moulds having protrusions and depressions of hexagonal cell pillar shapes formed on surfaces of the moulds, respectively, such that the polygonal or columnar cell pillars of the upper and lower plates are engaged and bonded to each other so as to constitute a honeycomb shape; and curved upper and lower face sheets composed of various materials, and attached to opposite surfaces of the upper and lower plates where the cell pillars are not formed.

2. The curved honeycomb structure according to claim 1, wherein the polygonal cell pillars comprise hexagonal cell pillars, triangular cell pillars, rectangular cell pillars or octagonal cell pillars.

3. The curved honeycomb structure according to claim 1, wherein each of the upper and lower plates having the cell pillars has apertures punctured around each cell pillar.

4. The apparatus according to claim 1, wherein the upper and lower plates are formed of other materials as well as the metallic or plastic material by injection molding, SMC, BMC, pulp molding, RIM, or RTM.

5. A method for producing a curved honeycomb structure, comprising the steps of: positioning respective flat plates composed of a metallic or plastic material between moulds having a curved shape, followed by compressing the flat plates to form respective curved plates; positioning the curved plates between moulds having protrusions and depressions of polygonal or columnar cell pillar shapes, followed by compressing the curved plate using a press machine or a vacuum molding machine so as to form polygonal or columnar cell pillars on a surface of each curved plate; disposing the curved plates having the cell pillars to face each other as an upper plate and a lower plate, respectively, followed by engaging and bonding the hexagonal cell pillars of the upper and lower plates to each other to form a curved honeycomb block; and attaching curved upper and lower face sheets composed of various materials to opposite surfaces of the curved honeycomb block where the cell pillars are not formed.

6. The method according to claim 5, wherein the polygonal cell pillars comprise hexagonal cell pillars, triangular cell pillars, rectangular cell pillars or octagonal cell pillars.

7. The method according to claim 5, further comprising: previously forming cutting lines on locations of each curved plate to form the cell pillars in order to enhance formability.

8. The method according to claim 5, wherein bonding of the cell pillars is accomplished via adhesives applied to an outer surface of each cell pillar, an adhesive molten material inserted between the cell pillars, or thermal bonding performed after coupling the curved upper and lower plates to each other.

9. The method according to claim 5, wherein each of the upper and lower plates having the cell pillars has apertures punctured around each cell pillar.

10. The method according to claim 5, wherein the upper and lower plates are formed of other materials as well as the metallic or plastic material by injection molding, SMC, BMC, pulp molding, RIM or RTM.
